(19) United States
(12) Patent Application Publication
(10) Pub. No.: US 2007/0029057 A1
(43) Pub. Date: Feb. 8, 2007

(54) Fitting for a folding sliding wall

(75) Inventor: Malte Schneider, Wenden (DE)

Correspondence Address: Friedrich Kueffner, Suite 910, 317 Madison Avenue, New York, NY, 10017, US

(73) Assignee: Sunflex Aluminiumsysteme GmbH

(21) Appl. No.: 11/444,978

(22) Filed: Jun. 1, 2006

(30) Foreign Application Priority Data
Jun. 2, 2005 (DE) 10 2005 025 821.2

(51) Int. Cl. E05D 15/26

(52) U.S. Cl. 160/199

(57) ABSTRACT

A folding sliding wall has a wall frame with at least one bottom rail and at least one ceiling rail. Carriages are arranged in the bottom and ceiling rails. An individual element or several of the individual elements that are pivotably connected to one another by hinges are provided, wherein the individual element or the several individual elements are arranged in the wall frame so as to be laterally movable within the wall frame. Each individual element has an element frame and a panel arranged in the element frame. A fitting is connected to the element frame and coupled by a bolt to one of the carriages. The fitting is attached to an end face of the element frame.

### BACKGROUND OF THE INVENTION

1. Field of the Invention

The invention relates to a folding sliding wall comprised of at least one individual element and/or several individual elements that are pivotably connected to one another by hinges and are arranged in a wall frame that is comprised of at least one bottom rail and a ceiling rail. The individual element or the connected individual elements can be laterally moved in the wall frame. Each individual element is comprised of an element frame and an element panel arranged in the element frame, wherein the element frames of the individual elements are coupled by fittings to carriages in the bottom rail and/or the ceiling rail.

2. Description of the Related Art

The term folding sliding wall refers to embodiments such as horizontal sliding walls, sliding turning elements and sliding elements in regard to the individual elements slidable relative to one another or to the vertical frame; this list is not meant to be limiting.

Such folding sliding walls are known in various configurations for numerous purposes. For example, in one embodiment, a sunroom is provided with a folding sliding door and its individual elements are comprised of a wooden and/or aluminum element frame with inserted windowpane as the element panel. Another configuration is a folding sliding wall designed for dividing a large room into two smaller rooms. For this purpose, a wooden panel or gypsum board panel is used, for example, to fill the element frame of an individual element in order to prevent that one can see through the sliding wall.

German patent 40 38 669 C2 discloses a folding sliding wall that can be opened and comprises several element frames, optionally provided with windowpanes, that are connected by hinges pivotably to one another or are connected to one another by other fittings at their vertically extending abutting locations (with the exception of the abutting location that forms the free end of the door).

German patent application 198 21 870 A1 discloses a folding sliding wall made of glass and having a ceiling rail and a bottom rail as well as a number of sections that are guided by means of rollers in the rails and supported slidably and/or pivotably in one of the rails. The sections are comprised of glass panes or other transparent panes that are arranged in wooden or metal profiled section frames.

In the known configurations the support of the individual elements is realized by means of carriages that are arranged in the bottom rail. For this purpose, the carriage preferably is provided with a bore on the vertical center axis into which a bolt is inserted that is connected to a fitting. Such a prior art fitting engages from above or below a hinge that is projecting from the element frame. The known fitting is of a C-shaped configuration and forms an extension of the hinges for inserting a continuous securing pin. One end of the C-shaped fitting is provided with a receptacle that can receive the bolt arranged in the carriage. This receptacle is designed similar to the shape of a quarter circle, for example.

The C-shaped known fitting is fastened to the hinges that are connected by a non-positive (force-locked) connection to the carriages in the bottom rail and the ceiling rail. For this purpose, inter alia, extra long securing pins are required that account for the entire length of the C-shaped fitting. Since the C-shaped fitting is mounted externally on the frame, i.e., is arranged on the visible side, the usual symmetric overall appearance changes. Moreover, as a result of the aforementioned shaping of the end of the fitting, the seal at the end faces of the element frame is interrupted so that at this location air, water, smoke etc. can penetrate into the room, respectively. The known configuration of the fitting is moreover large and heavy because the weight of the individual elements is distributed through the projecting hinges into the C-shaped fitting and from there through the bolt into the carriage. The weight therefore provides in this configuration a moment that must also be taken into consideration.

### SUMMARY OF THE INVENTION

It is an object of the present invention to improve the fitting of the aforementioned kind in such a way that the aforementioned disadvantages are prevented, the amount of material is reduced, and the assembly is simplified.

In accordance with the present invention, this is achieved in that the fitting for receiving the bolt is configured to be attached to the end face of the element frame of the individual elements.

It has been recognized that an attachment on the end face of the element frame provides for an optimal weight introduction of the individual elements into the carriages. The entire weight is thus applied in the same vertical plane of individual element and fitting. A displacement as a result of the moment as in the known configuration is prevented.

By designing the fitting as a bent U-shaped profile section on the side opposite the bolt a guide element is provided that can be moved on a rail that is formed on the end faces of the element frame of the individual elements or a rail that is separately mounted. Such a configuration facilitates assembly of a folding sliding wall.

In a preferred embodiment, the fitting is a cast part. However, it is also possible to design the fitting as a die-cut bent part.

### BRIEF DESCRIPTION OF THE DRAWING

In the drawing:

FIG. 1 is a perspective illustration of a folding sliding wall with three individual elements and a wall frame showing the device in a partially open position;

FIG. 2 is a perspective illustration of a bottom rail with carriage and fitting according to the invention;

FIG. 3 is a sectioned plan view (section III-III of FIG. 2) of the fitting when the folding sliding wall is closed; and

FIG. 4 is a front view of the lower end of the end face of an element frame with a fitting according to the invention and bottom rail with carriage in a sectioned view.

### DESCRIPTION OF THE PREFERRED EMBODIMENTS

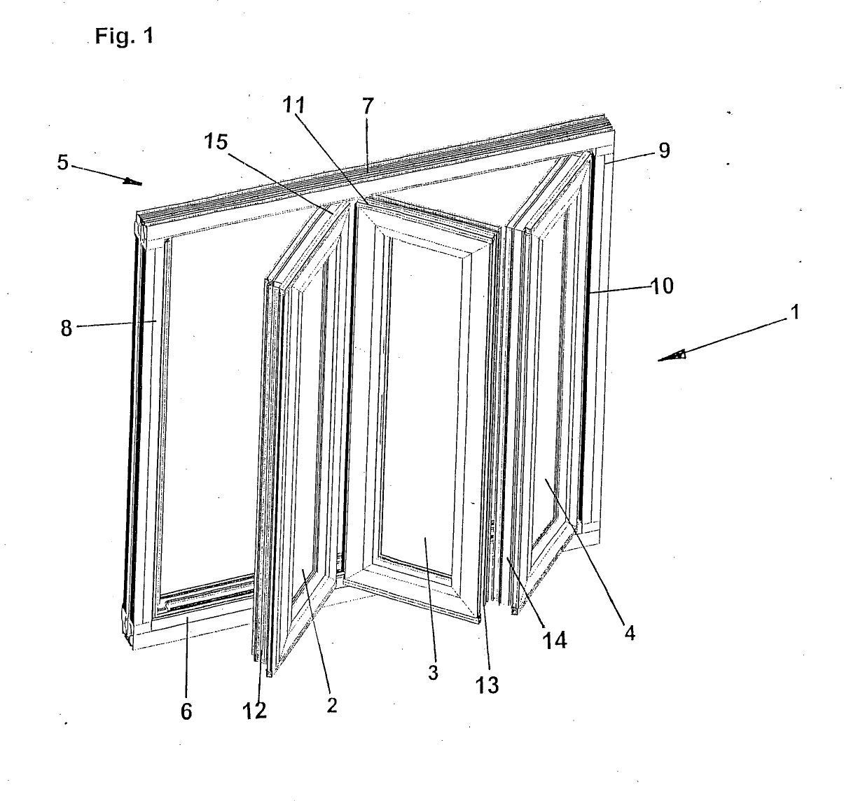

The folding sliding wall 1 illustrated in FIG. 1 is comprised of three individual elements 2, 3, 4. The folding sliding wall 1 is surrounded by a wall frame 5 that is comprised of a bottom rail 6, a ceiling rail 7, a left post 8 and a right post 9. The individual elements 2, 3, 4 are pivotably connected to one another by hinges (not illustrated). For opening the folding sliding wall 1 the individual elements 2, 3, 4 connected to one another are fastened in the area of their vertical ends 11 and 15 to carriages (not illustrated) in the bottom rail 6 and the ceiling rail 7. The end faces 12, 13, and 14 can move freely within the room.

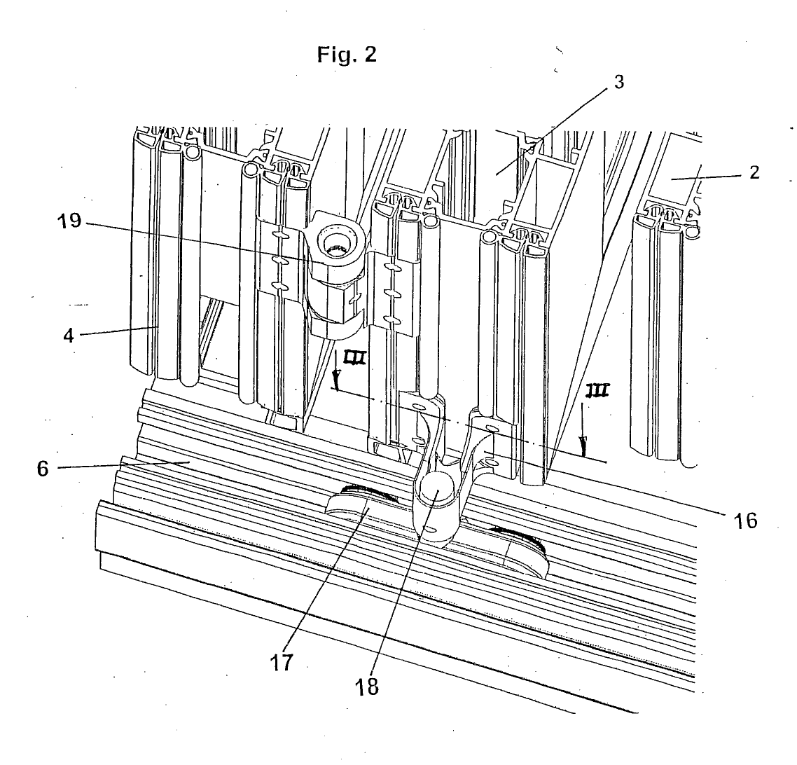

The arrangement and attachment of a fitting 16 according to the invention is illustrated in FIG. 2 wherein a carriage 17 is movably arranged in the bottom rail 6. The carriage 17 and the fitting 16 are connected to one another by a bolt 18 in a non-positive (force-locked) and/or positive way. The individual elements 3, 4 are pivotably connected to one another by a hinge 19, for example. The attachment of the fitting 16 is realized by screws, for example.

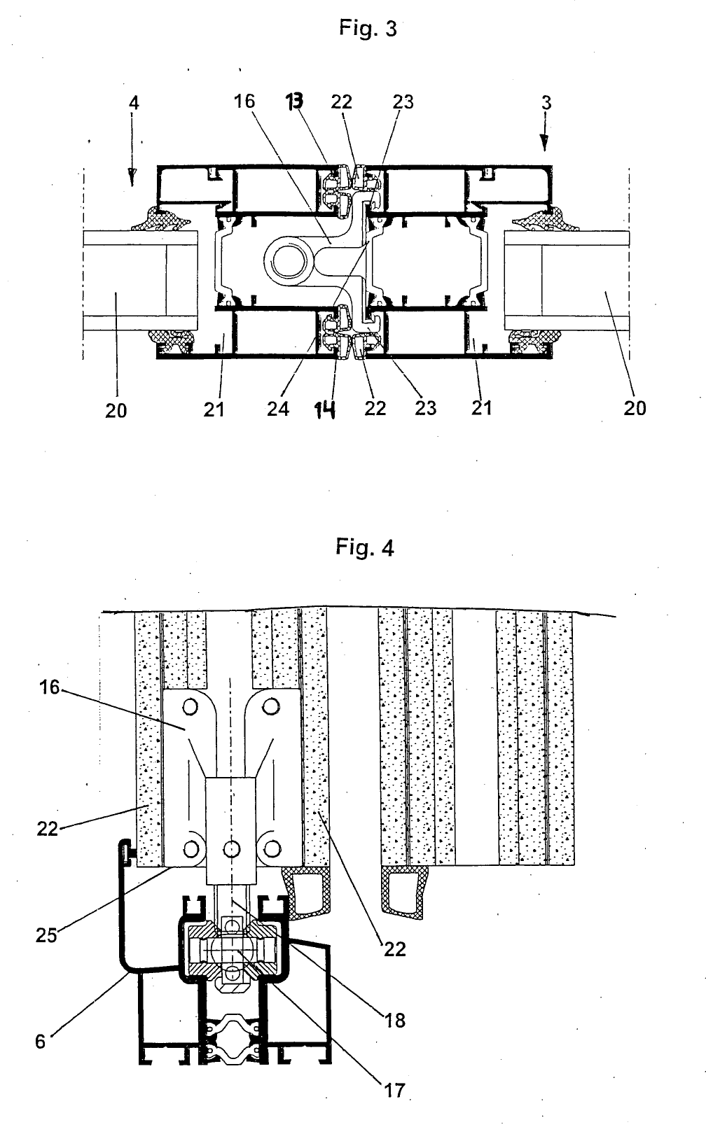

In FIG. 3, the cross-section of the individual elements 3, 4 is illustrated in a section view. The element panel 20 is comprised of, for example, a double pane window. The element frame 21 is manufactured from extruded profiled aluminum sections that have several chambers with different cross-sections, respectively. The folding sliding wall 1 has end faces 13, 14 that are positioned opposite one another in the closed state of the wall 1 and are provided on the edges or corner areas with sealing strips 22. The sealing strips 22 are comprised simply of a hollow chamber in the area of the fitting 16. The corners 23 of the fitting 16 are U-shaped and can therefore be placed onto and attached to a special rail 24 of the element frame 21. The attachment is realized, for example, by screwing, but there is also the possibility of providing a clamping connection.

The fitting 16, as illustrated in FIG. 4, has such a width that at least one hollow chamber of the sealing strips 22 is provided completely on the end face, respectively. A gap is thus prevented. Moreover, the fitting 16 is attached to the lowermost vertical end 25 of the element frame 21 and can therefore transmit the weight of the individual element or elements 2, 3, 4 directly through the bolt 18 onto the carriage 17 and the bottom rail 6.

The configuration of the fitting 16 in accordance with the invention makes it possible that the assembly is carried out by a single person. For this purpose, the fitting 16 can be moved, for example, on the rail 24. The weight acts vertically downwardly while in the C-shaped prior art configuration a moment is generated that requires alignment of the individual elements in several directions during assembly.

While specific embodiments of the invention have been shown and described in detail to illustrate the inventive principles, it will be understood that the invention may be embodied otherwise without departing from such principles.

What is claimed is:

1. A folding sliding wall comprising:
a wall frame comprising at least one bottom rail and at least one ceiling rail;
carriages arranged in the at least one bottom rail and the at least one ceiling rail;
an individual element or several of the individual elements that are pivotably connected to one another by hinges, wherein the individual element or the several individual elements are arranged in the wall frame so as to be laterally movable within the wall frame;
wherein each individual element is comprised of an element frame and an element panel arranged in the element frame;
wherein a fitting is connected to the element frame and coupled by a bolt to one of the carriages;
wherein the fitting is attached to an end face of the element frame.

2. The folding sliding wall according to claim 1, wherein the fitting is screwed onto the element frame.

3. The folding sliding wall according to claim 1, wherein the fitting is clamped to the element frame.

4. The folding sliding wall according to claim 1, wherein the fitting and the bolt form a monolithic part.

5. The folding sliding wall according to claim 1, wherein the bolt is conical.

6. The folding sliding wall according to claim 1, wherein the bolt is cylindrical.

7. The folding sliding wall according to claim 1, wherein the fitting is attached so as to be flush with a vertical end of the element frame.

8. The folding sliding wall according to claim 1, wherein the fitting is connected at a spacing to a vertical end of the element frame.
